(19) United States
(12) Patent Application Publication
(10) Pub. No.: US 2008/0021954 A1
(43) Pub. Date: Jan. 24, 2008

(54) METHOD AND APPARATUS TO FACILITATE PROVIDING AND UTILIZING CALENDAR UPDATES

(75) Inventors: Deborah A. Matteo, Schaumburg, IL (US); Thomas J. Mactavish, Inverness, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/459,456

(22) Filed: Jul. 24, 2006

(51) Int. Cl. G06F 15/16

(52) U.S. Cl. 709/203; 709/227

(57) ABSTRACT

A digital processing platform having a modifiable calendar as corresponds to a source user receives (101) a calendar update as corresponds to the source user. An opportunity is then provided (102) to the user to permit the user to select recipient users to receive that calendar update. Upon then receiving (103) information in this regard that identifies at least one recipient user who is to receive the calendar update, the calendar update (sans the modifiable calendar itself) is transmitted (104) to the identified recipient user. A receiving digital processing platform can then provide (302) a recipient user with an opportunity to select a particular treatment of that calendar update with respect to their own modifiable calendar. This can comprise adding the calendar update to the modifiable calendar, adding the calendar update as a for-informational-purposes-only item to the modifiable calendar, and/or refusing to add the calendar update to the modifiable calendar.

### TECHNICAL FIELD

This invention relates generally to digitally-based modifiable calendars and more particularly to sharable calendar content.

### BACKGROUND

Digitally-based modifiable calendars are known in the art. Such calendars are frequently maintained on (or accessible via) a variety of digital processing platforms such as one-way and two-way communications devices, personal digital assistants, personal computers, and so forth. These calendars typically present ordinary calendar data (such as information regarding years, months, weeks, days and dates, holidays, and so forth) and also usually provide the user with an opportunity to modify the calendar to include and/or reflect in some useful way the personal appointments and schedule of that user.

The sharing of a digitally-based modifiable calendar is also known in the art. In some cases, a given user group (such as a work group at a given business or a group of family members) each has access to a shared master calendar that contains the appointments and scheduling information for all of the users. In other cases, the calendars are kept by the corresponding users but are each viewable and accessible by all the members of the user group. Such approaches work well enough when the scheduling information comprises only information that is genuinely relevant to the purpose and interests of everyone in the user group. In many cases, however, a given user will wish to include scheduling information on their own calendar that they do not necessarily wish to share, in full or at all, with other members of their group.

At present, such a user must typically either avoid placing such information into their calendar or must essentially enter the event in a disguised fashion. In some cases, the calendaring system itself will permit a user to designate a given calendar entry as being “private” or the like and such a designation will in turn serve to prohibit at least some group members from viewing the underlying calendar event information.

Such solutions do not meet all present needs and requirements. In particular, such solutions tend to either force the user to effectively under-utilize the capabilities of the calendaring system (in order to effect some crude control over how their calendar event information is disseminated and/or viewed) and/or to place undue limits on the user with respect to how such a calendaring system can be used and leveraged to the benefit of all.

### BRIEF DESCRIPTION OF THE DRAWINGS

The above needs are at least partially met through provision of the method and apparatus to facilitate providing and utilizing calendar updates described in the following detailed description, particularly when studied in conjunction with the drawings, wherein:

FIG. 1 comprises a flow diagram as configured in accordance with various embodiments of the invention;

FIG. 2 comprises an illustrative screen shot as configured in accordance with various embodiments of the invention;

FIG. 3 comprises a flow diagram as configured in accordance with various embodiments of the invention;

FIG. 4 comprises an illustrative screen shot detail as configured in accordance with various embodiments of the invention;

FIG. 5 comprises an illustrative screen shot detail as configured in accordance with various embodiments of the invention; and

FIG. 6 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a digital processing platform having a modifiable calendar as corresponds to a source user can receive, through a corresponding user interface, a calendar update to that modifiable calendar as corresponds to the source user. An opportunity can then be provided to the source user to permit the latter, via that user interface, to select recipient users to receive that calendar update. Upon then receiving information in this regard that identifies at least one recipient user who is to receive the calendar update, the calendar update (sans the modifiable calendar itself) is transmitted to the identified recipient user. This, in turn, facilitates the recipient user entering that calendar update into their own modifiable calendar.

The aforementioned opportunity can serve, for example, to facilitate identification of a network address as corresponds to an intended recipient user. By one approach, if desired, this can also comprise permitting the source user to select recipient users to receive the calendar update in conjunction with selection of a particular informational status for that calendar update. Such an informational status might comprise, for example, the strength of the scheduling conflict to be accorded to the recipient user with respect to the calendar update.

These teachings also provide generally for receiving, again at such a digital processing platform, a transmission such as the calendar update transmission described above. In such a case, the recipient user can then be provided with an opportunity to select a particular treatment of the calendar update with respect to their own modifiable calendar. For example, by one approach, this can comprise providing an opportunity to select to add the calendar update as an appointment to their modifiable calendar. By another approach, this can comprise providing an opportunity to select to add the calendar update as a for-informational-purposes-only item to their modifiable calendar. By yet another approach, this can comprise providing an opportunity to select to refuse to add the calendar update (as an appointment or otherwise) to their modifiable calendar.

So configured, calendar updates can be formed in a manner that is highly relevant to and usable by the source user while nevertheless providing great flexibility with respect to how that information is then shared and further with respect to what amount of that information (or in what form that information) is shared. Accordingly, a source user can avoid any need to disguise their calendar entries or to otherwise code them in some fashion to avoid third party scrutiny while still retaining the benefit and power of sharing calendar information amongst a corresponding user group. Those skilled in the art will further recognize and appreciate that these teachings are highly amenable to near real-time updating and hence can serve to ensure that such users are more likely to have current information regarding other person's calendars as compared to many other prior art approaches.

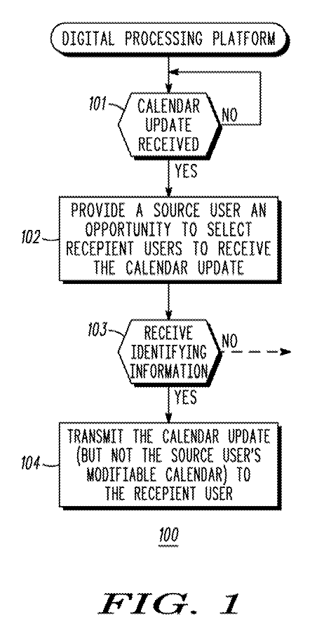

These and other benefits may become clearer upon making a thorough review and study of the following detailed description. Referring now to the drawings, and in particular to FIG. 1, these teachings are particularly useful when applied in conjunction with a digital processing platform having a modifiable calendar as corresponds to a source user. Various such platforms are known in the art and others will no doubt be developed in the future. These teachings are not particularly sensitive to the selection of any particular choice in this regard.

By one illustrative process 100, this digital processing platform receives 101, via a corresponding user interface (such as a keypad-based, cursor-based, or speech-based input mechanism), a calendar update for the modifiable calendar. This might comprise, for example, an appointment for the user, a presentation that the user wishes to observe, and so forth. This process 100 then provides 102 that user, again via a user interface, an opportunity to permit that user to select one or more recipient users to also receive that calendar update. By one approach, these two steps can comprise clearly delineated and segregated activities. By another approach, if desired, these steps can be partially or wholly integrated with one another. When segregated, either step can precede the other, in whole or in part.

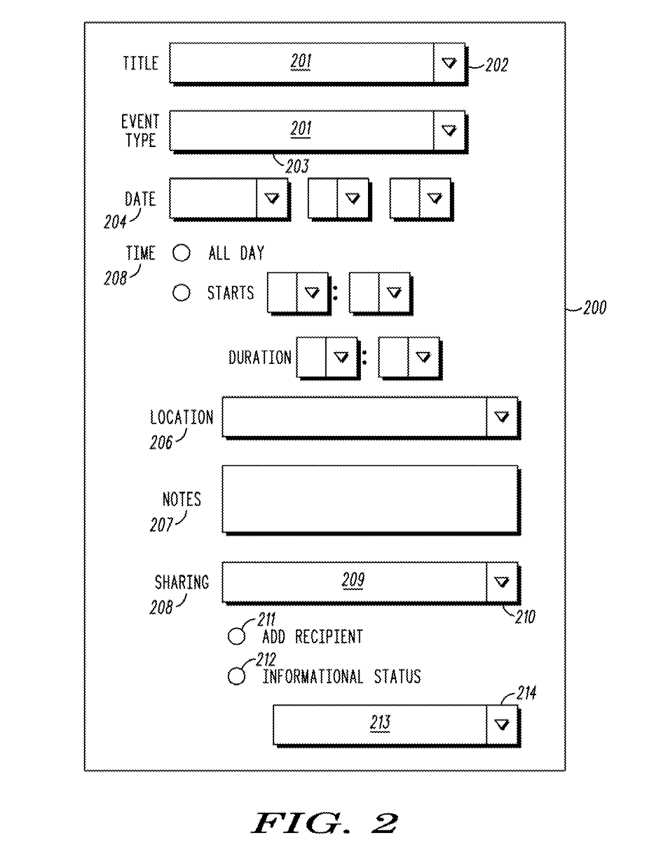

By way of illustration and not as a suggestion of limitation, an exemplary approach in this regard appears in FIG. 2. FIG. 2 presents a screen shot 200 as might be presented to a user of such a digital processing platform when experiencing the aforementioned steps. In this example, the screen shot 200 provides a field 201 where the user can enter a title for the new calendar event. This data entry opportunity also comprises, in this example, a button 202 to permit, for example, default, previously, and/or most recently entered titles for other calendar events to be presented as candidates to the user. Such a candidate selection technique is generally known in the art and requires no further elaboration here.

This screen shot 200 provides other data entry opportunities as might reasonably pertain to a given calendar entry. In this illustrative example, these data entry opportunities comprise an event type entry area 203, a date entry area 204, a time entry area 205, a location entry area 206, and a notes entry area 207. So configured, for example, the user could specify a new calendar event entitled “Soccer practice” that is a “sports” event type and that is scheduled for Jul. 7, 2006 at 2 PM for 2 hours at “Lippold Field” with an additional note indicating “After practice snacks!” Once entered, and in general accordance with present modifiable calendar practice, this information would be used to update the user's modifiable calendar as maintained by their digital processing platform of choice.

In this illustrative example, however, these teachings also provide the user with an opportunity to share 208, and to control the sharing of, this new calendar event. This can comprise, for example, a field 209 where the user can enter or otherwise select a network address as corresponds to an intended recipient user. If desired, this data entry opportunity can further comprise a candidate presentation button 210 as described above to permit previously entered or otherwise previously established potential recipients to be presented for consideration of the user. These might comprise recently entered names, network addresses, or other identifying or characterizing information, names/addresses as have been harvested from incomimg calendar updates from other users, names/addresses as have been obtained from an address book or other source provided by the user and/or that is otherwise available for these purposes, and so forth. It would also be possible for a particular candidate name to itself serve as an alias or identifier for a collection of individual recipients.

In this example the user also has an opportunity 211 to specifically add more than one such intended recipient. By this approach, for example, the user can elect to forward the new calendar update to each of a plurality of recipients. These might, in the aggregate, comprise a work group, a family group, or some other shared affinity group of choice.

By one approach, the user can make such selections and provide such instructions regarding sharing in conjunction with the creation/submission of each new calendar event. In combination with such an approach, or in lieu thereof, these teachings would also accommodate pre-defining such sharing instructions in a maimer that correlates such instructions with other data entry choices. To illustrate, the user could be permitted to pre-establish that all calendar events having a “work” event type be automatically shared with a predetermined set of identified co-workers. As another illustration, the user could be permitted to pre-establish that all calendar events designated as a “family” event type be automatically shared with a predetermined set of identified family members. In such a case, if desired, the calendar event submission opportunity could then also present an opportunity for the user to cancel or amend/alter the predetermined sharing instructions as apply to a given calendar event entry.

In some cases, the user may be willing to share their calendar entry with a particular recipient but may not wish to share the calendar entry in its original form. For example, a data entry for a medical appointment may include information that the user considers personal. As another example, a given data entry may represent a medium priority item for the user. In such a case, the user may be willing to break that appointment for some shared recipients (such as a supervisor or spouse) but unwilling to break that appointment for other shared recipients (such as workplace peers).

To accommodate such scenarios, if desired, these teachings will also accommodate providing the user with an opportunity 212 to alter the informational status to be accorded to a given shared calendar event. This might comprise, in some instances, providing a data entry/selection opportunity 213 (with or without a candidate presentation button 214 capability) to permit a user to define, or select, the desired treatment. This might comprise, for example, abridging the calendar event content as will be provided to a given recipient user. For example, a calendar event entitled “Doctor appointment” might instead be presented as “Private.”

As another illustrative example, this informational status can pertain to a strength of a scheduling conflict as corresponds to the recipient user with respect to the calendar update. For example, the calendar event may be presented to a first class of recipient users (such as workplace peers) as a firm scheduling commitment that the sourcing user cannot break. Accordingly, it may be expected that these recipient users will respect that schedule and thereafter attempt to avoid creating scheduling conflicts. At the same time, however, that same calendar event might be presented to another class of recipient users (such as managers and supervisors at the workplace) as a soft scheduling commitment; i.e., one that the sourcing user is willing to break should the recipient user need to schedule a conflicting activity for that sourcing user.

Returning again to FIG. 1, upon receiving 103 identifying information that identifies at least one recipient user who is to receive the calendar update, this process 100 provides for transmitting 104 that calendar update in a maimer that effects and respects the sharing instructions and limitations set forth by the source user. By these teachings, this transmission comprises a transmission of the calendar event itself (as modified or not in accordance with the description set forth above) but does not comprise a transmission of the source user's modifiable calendar itself (i.e., a substantially complete version of the source user's modifiable calendar). This transmission can make use of any known or hereafter developed technology or technique of choice and may certainly comprise, for example, a wireless transmission (using a wide area, local area, or close proximity mechanism of choice).

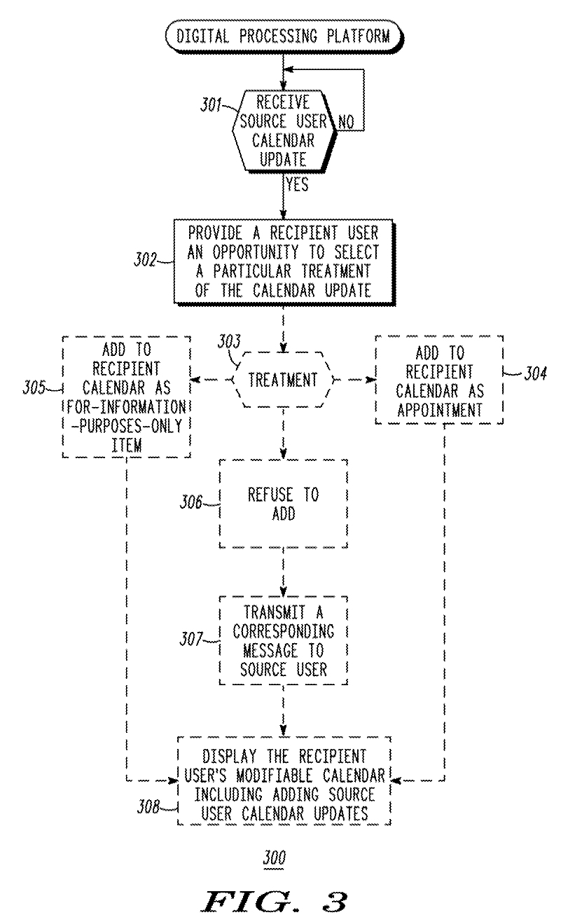

With reference now to FIG. 3, these teachings will also accommodate a process 300 that provides for a digital processing platform (that has a modifiable calendar as corresponds to a recipient user) receiving 301 such a transmission. This process 300 then provides 302 an opportunity to the recipient user (via a corresponding user interface of choice) to select a particular treatment of that received calendar update with respect to the recipient user's modifiable calendar. This opportunity can assume any of a wide variety of forms including, for example, presenting an opportunity to pre-establish such treatment and/or to prompt a selection in this regard at a time of initially entering a new calendar update.

The particular treatment 303 selected can vary with the needs, options, and/or requirements as characterize a given application setting. By one approach, one selectable treatment in this regard can comprise selecting to automatically add 304 the received calendar update as an appointment to the recipient user's modifiable calendar. This might comprise an event that the recipient user is expected to attend such as a meeting.

As another approach, another selectable treatment in this regard can comprise selecting to automatically add 305 the calendar update as a for-informational-purposes-only item to the recipient user's modifiable calendar. This might comprise, for example, an event that the recipient user is not expected to attend but may be expected to observe and respect as a scheduling conflict for the source user. In such a case, as noted above, the source user may have provided informational status regarding this calendar item that may, in turn, serve to further indicate various degrees of privacy, priority, and/or relative strength of the scheduling conflict as per, for example, that particular recipient user.

As yet another example, another selectable treatment in this regard can comprise selecting to refuse to add 306 the calendar item to the recipient user's modifiable calendar (as an appointment, as a for-informational-purposes-only item, and/or otherwise as desired). In such a case, if desired, this process 300 can optionally further accommodate then transmitting 307 a corresponding message to the source user to advise the source user that the proffered calendar update has been refused. When effecting this step, if desired, the recipient user can also optionally be afforded an opportunity to enter or select additional information (such as an explanation as to why the calendar update is being refused) to include with such a transmission.

Thus process 300 may also, if desired, optionally provide for displaying 308 the recipient user's modifiable calendar via, again, a user interface of choice as corresponds to the digital processing platform. This can comprise, of course, displaying received and accepted/added calendar updates. For example, and referring now to FIG. 4, a week's worth of calendar information 401 can be displayed that includes both calendar events 405 and 406 that have been entered by the recipient user themselves as well as calendar events 402 and 403 that have been received and added to the modifiable calendar by the recipient user.

By one approach, calendar events that have been received from other source users (and/or source user groups) can be displayed in a manner that provides some indication of their origin. For example, by one approach, work related calendar events from external sources can be demarked with a green color while family related calendar events from external sources can be indicated with a red color. These teachings will also accommodate providing the viewer with a capability of displaying such information in an abridged manner. For example, and referring now to FIG. 5, the viewer might select to display only those calendar updates 402 and 403 as correspond to a particular selected source user (such as a spouse) and to exclude a display of any other calendar events.

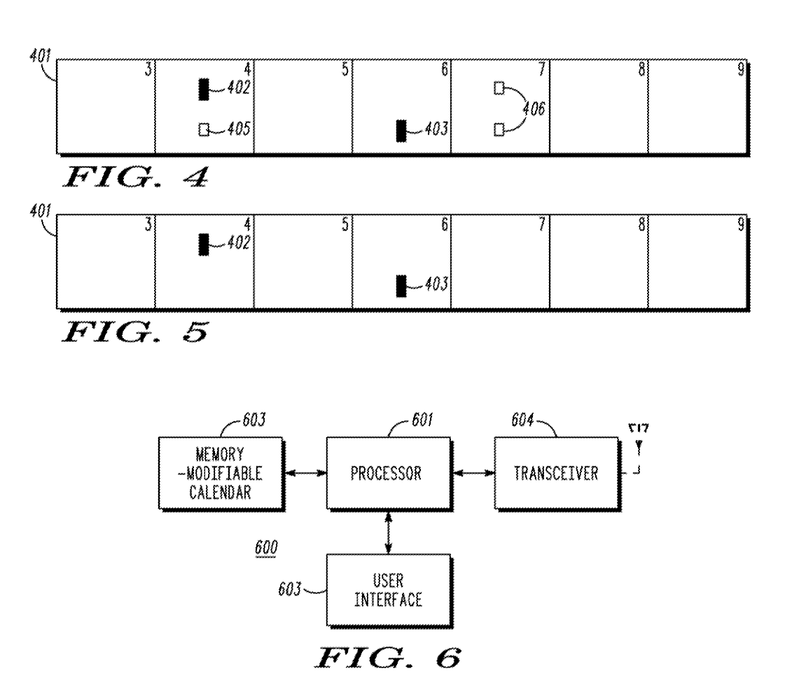

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 6, an illustrative approach to such a platform will now be provided.

In this illustrative embodiment a digital processing platform 600 has a processor 601 that operably couples to a memory 602, a user interface 603, and a transceiver 604. The memory 602 serves, for example, to store the aforementioned modifiable calendar as corresponds to a given platform user. The user interface 603 can comprise any such interface as is presently known or hereafter developed but will typically provide both a user input mechanism and a user output mechanism. The transceiver 604 may comprise, if desired, a wireless platform and, being a transceiver, have both a transmitter to facilitate the transmission of calendar updates and a receiver to facilitate receiving calendar updates as described above.

The processor 601 is configured and arranged (via, for example, appropriate programming as will be well understood by those skilled in the art) to effect selected teachings as have been set forth herein. This can include, for example, receiving calendar updates from the platform user via the user interface 603, providing an opportunity to the platform user to select recipient users to receive information regarding that calendar update, and causing the transceiver 604 to transmit the calendar update information to selected recipient users as described above. This can also include, as desired, receiving calendar updates from other platform users via the transceiver 604 and providing an opportunity to this platform user to select a particular treatment of such received calendar updates with respect to their own modifiable calendar as is also described above.

Those skilled in the art will recognize and understand that such an apparatus 600 may be comprised of a plurality of physically distinct elements as is suggested by the illustration shown in FIG. 6. It is also possible, however, to view this illustration as comprising a logical view, in which case one or more of these elements can be enabled and realized via a shared platform. It will also be understood that such a shared platform may comprise a wholly or at least partially programmable platform as are known in the art.

So configured, a user of modifiable calendars has great flexibility to define and enter calendar updates in a manner that is both useful for their own purposes while also providing a controlled sharing of corresponding information with selected others. The nature of this control can vary with the application setting but can readily accommodate a relatively wide range of choices in this regard to facilitate protecting the user's privacy and/or schedule. These teachings are readily employed with a variety of modifiable calendars and digital processing platforms and can be implemented and utilized with little or no training requirements.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a digital processing platform having a modifiable calendar as corresponds to a source user:
receiving via a user interface a calendar update to the modifiable calendar as corresponds to the source user;
providing an opportunity to permit the source user, via the user interface, to select recipient users to receive the calendar update;
receiving information, via the user interface, that identifies at least one recipient user who is to receive the calendar update;
transmitting the calendar update, but not the modifiable calendar as corresponds to the source user, to the recipient user to facilitate entering the calendar update into a modifiable calendar as corresponds to the recipient user.

2. The method of claim 1 wherein receiving information comprises, at least in part, identifying, at least in part, a network address as corresponds to recipient user.

3. The method of claim 1 wherein providing an opportunity to permit the source user, via the user interface, to select recipient users to receive the calendar update comprises providing an opportunity to permit the source user, via the user interface, to select recipient users to receive a particular category of calendar update.

4. The method of claim 3 wherein receiving information, via the user interface, that identifies at least one recipient user who is to receive the calendar update comprises receiving information, via the user interface, that identifies at least one recipient user who is to receive subsequent calendar updates as fall within the particular category of calendar update.

5. The method of claim 1 wherein transmitting comprising wirelessly transmitting.

6. The method of claim 1 wherein providing an opportunity to permit the source user, via the user interface, to select recipient users to receive the calendar update further comprises providing an opportunity to permit the source user to designate a particular informational status for the calendar update.

7. The method of claim 6 wherein the particular information status pertains to a strength of a scheduling conflict as corresponds to the recipient user with respect to the calendar update.

8. A method comprising:
at a digital processing platform having a modifiable calendar as corresponds to a recipient user:
receiving a transmission comprising a calendar update to a modifiable calendar, but not the modifiable calendar itself, as corresponds to a source user;
providing an opportunity to the recipient user via a user interface to select a particular treatment of the calendar update with respect to the modifiable calendar as corresponds to the recipient user.

9. The method of claim 8 wherein receiving a transmission comprises, at least in part, receiving a wireless transmission.

10. The method of claim 8 wherein providing an opportunity to select a particular treatment of the calendar update comprises, at least in part, providing an opportunity to select to add the calendar update as an appointment to the modifiable calendar as corresponds to the recipient user.

11. The method of claim 10 wherein providing an opportunity to select a particular treatment of the calendar update comprises, at least in part, providing an opportunity to select to refuse to add the calendar update as an appointment to the modifiable calendar as corresponds to the recipient user.

12. The method of claim 11 further comprising:
in response to the recipient user selecting to refuse to add the calendar update as an appointment, transmitting a corresponding message to the source user.

13. The method of claim 11 wherein providing an opportunity to select a particular treatment of the calendar update comprises, at least in part, providing an opportunity to select to add the calendar update as a for-informational-purposes-only item to the modifiable calendar as corresponds to the recipient user.

14. The method of claim 8 further comprising:
displaying the modifiable calendar as corresponds to the recipient user, wherein displaying the modifiable calendar comprises, at least in part, displaying calendar updates from source users as have been received and added to the modifiable calendar as corresponds to the recipient user.

15. The method of claim 14 wherein displaying calendar updates from source users as have been received and added to the modifiable calendar as corresponds to the recipient user further comprises displaying only those calendar updates as correspond to source users that the recipient user has selected.

16. A digital processing platform comprising:
a memory having a modifiable calendar as corresponds to a given platform user stored therein;
a user interface;
a transmitter;
a processor operably coupled to the memory, the user interface, and the transmitter and being configured and arranged to:
receive via the user interface a calendar update to the modifiable calendar;
provide an opportunity to permit the given platform user, via the user interface, to select recipient users to receive the calendar update;
receive information, via the user interface, that identifies at least one recipient user who is to receive the calendar update;
transmit, using the transmitter, the calendar update, but not the modifiable calendar, to the recipient user to facilitate entry of the calendar update into a modifiable calendar as corresponds to the recipient user.

17. The digital processing platform of claim 16 wherein the transmitter comprises a wireless transmitter.

18. The digital processing platform of claim 16 wherein the processor is further configured and arranged to:
receive a transmission comprising a calendar update to a modifiable calendar, but not the modifiable calendar itself, as corresponds to a source user;
provide an opportunity to the given platform user via the user interface to select a particular treatment of the calendar update with respect to the modifiable calendar as is stored in the memory.

19. The digital processing platform of claim 18 the opportunity to select a particular treatment of the calendar update comprises, at least in part, an opportunity to select from amongst:
adding the calendar update as an appointment to the modifiable calendar as is stored in the memory;
refusing to add the calendar update as an appointment to the modifiable calendar as is stored in the memory;
adding the calendar update as a for-informational-purposes-only item to the modifiable calendar as is stored in the memory.
